(19) United States
(12) Patent Application Publication
(10) Pub. No.: US 2012/0161548 A1
(43) Pub. Date: Jun. 28, 2012

(54) WALL OUTLET DEVICE, POWER MANAGEMENT SYSTEM HAVING SAME AND METHOD FOR CONTROLLING THEREOF

(75) Inventors: JINSOO HAN, Daejeon (KR); Chang-Sic CHOI, Daejeon (KR); Wan Ki PARK, Daejeon (KR); Youn Kwae JEONG, Daejeon (KR); Jeong In LEE, Daejeon (KR); IL WOO LEE, Daejeon (KR)

(73) Assignee: Electronics and Telecommunications Research Institute, Daejeon (KR)

(21) Appl. No.: 13/301,589

(22) Filed: Nov. 21, 2011

(30) Foreign Application Priority Data
Dec. 23, 2010 (KR) 10-2010-0133552

(51) Int. Cl. H01H 35/00

(52) U.S. Cl. 307/126

(57) ABSTRACT

A power management system includes a signal repeater and a wall outlet device having the electrical appliance plugged therein. The signal repeater is configured to receive a power control signal from a remote controller and generate a power management signal in correspondence with the power control signal, wherein the power control signal includes a power-on signal or a power-off signal used to turn-on or turn-off an electrical appliance, respectively. The wall outlet device is configured to selectively perform the supply of electric power to the electrical appliance or the interruption of electric power being supplied to the electrical appliance in response to the power management signal from the signal repeater.

### CROSS-REFERENCE TO RELATED APPLICATION(S)

The present invention claims priority of Korean Patent Application No. 10-2010-0133552, filed on Dec. 23, 2010, which is incorporated herein by reference.

### FIELD OF THE INVENTION

The present invention relates to a power management system used to apply and interrupt an electric power to and from an electrical appliance. More particularly, the present invention relates to a wall outlet device for interrupting an electric power to an electrical appliance at a time point when the electrical appliance is turned-off via a remote controller to thereby prevent standby power consumption, and a power management system having the wall outlet device and a control method thereof.

### BACKGROUND OF THE INVENTION

Nowadays, in order to reduce a standby power, there are researched a variety of techniques adaptable to completely interrupt electric power being supplied from a socket or a wall outlet to an electrical appliance when the electrical appliance plugged in the socket enters into a standby mode.

A technique to automatically interrupt the electric power employs a socket for automatically cutting off a standby power. The socket monitors the electric power being consumed by an electrical appliance in a standby mode and automatically interrupts the electric power when the consumed electric power is less than a threshold value, e.g., the standby power. More specifically, in case that the electrical appliance is in a standby mode or in a state of the electrical appliance not being driven depending on operation of the electrical appliance, the socket monitors a consumed electric power by the electrical appliance during a fixed time period and interrupts the electric power to the electrical appliance when the consumed electric power is less than a threshold value, thereby reducing the standby power.

Although the above-mentioned socket is capable of reducing the standby power, it leaves the standby power unreduced during the fixed time period necessary to determine the standby mode.

As such, standby power is unnecessarily consumed during the short time period.

### SUMMARY OF THE INVENTION

In view of the above, the present invention provides a method and a wall outlet device that automatically interrupt the supply of electric power to an electrical appliance in the wall outlet device at a time point when the electrical appliance is turned-off.

Further, the present invention provides a method and a power management system that are adaptable to reduce a standby power during a standby mode of an electrical appliance plugged in a wall outlet device.

In accordance with a first aspect of the present invention, there is provided a power management system, which includes:

a wall outlet device having an electrical appliance plugged therein and configured to selectively perform the supply of electric power to the electrical appliance or the interruption of electric power being supplied to the electrical appliance in response to a power management signal; and

a signal repeater configured to receive a power control signal from a remote controller and generate the power management signal in correspondence with the power control signal, wherein the power control signal includes a power-on signal or a power-off signal used to turn-on or turn-off the electrical appliance, respectively.

Preferably, the wall outlet device includes:

a communication unit for receiving the power management signal from the signal repeater;

a measurement unit for measuring electric power being consumed in the electrical appliance;

a switching unit for selectively supplying the electric power to the electrical appliance or interrupting the electric power being supplied to the electrical appliance; and

a control unit for controlling the switching unit depending on the power management signal and/or the consumed electric power.

Preferably, the control unit is configured to:

supply the electric power to the electrical appliance when the power management signal in correspondence with the power-on signal is received, in a status that the supply of electric power to the electrical appliance has been interrupted; and

interrupt the electric power to the electrical appliance when the power management signal in correspondence with the power-off signal, in a status that the electric power is being supplied to the electrical appliance.

Further, the control unit is configured to:

continue the supply of the electric power to the electrical appliance when the consumed electric power during a fixed time period is not less than a threshold value, in a status that the electric power is being supplied to the electrical appliance; and

interrupt the electric power to the electrical appliance when the consumed electric power in the electrical appliance during a fixed time period is less than a threshold value, in a status that the electric power is being supplied to the electrical appliance.

Preferably, the signal repeater includes:

a receiving unit for receiving the power control signal from the remote controller;

a control unit for generating the power management signal in correspondence with the received power control signal; and

a communication unit for transmitting the power management signal to the wall outlet device.

Preferably, the power management system further includes a transmission unit for transmitting the same power-on signal as that received by the receiving unit to the electrical appliance in a state that the supply of electric power to the electrical appliance has been interrupted.

In accordance with a second aspect of the present invention, there is provided a method of managing electric power in a power management system including a signal repeater and a wall outlet device having an electrical appliance plugged therein, which includes:

receiving, at the signal repeater, a power control signal from a remote controller to generate a power management signal in correspondence with the power control signal, wherein the power control signal includes a power-on signal or a power-off signal used to turn-on or turn-off the electrical appliance, respectively; and

selectively performing, at the wall outlet device, in response to the power management signal, the supply of electric power to the electrical appliance or the interruption of electric power to the electrical appliance.

Preferably, the supply of electric power to the electrical appliance is performed when the power management signal in correspondence with the power-on signal is received, in a status that the electric power to the electrical appliance has been interrupted.

Preferably, the interruption of electric power to the electrical appliance is performed when the power management signal in correspondence with the power-off signal is received, in a status that the electric power is being supplied to the electrical appliance.

Preferably, the method further includes:

measuring, at the wall outlet device, a consumed electric power in the electrical appliance during a fixed time period, in a state that the electric power is being supplied to the electrical appliance;

continuing to supply the electric power to the electrical appliance if the consumed electric power is not less than a threshold value; and

interrupting the electric power being supplied to the electrical appliance when the consumed electric power is less than a threshold value.

Preferably, the method further includes transmitting the same power-on signal as that received by the signal repeater to the electrical appliance in a state that the supply of electric power from the wall outlet device has been interrupted.

### BRIEF DESCRIPTION OF THE DRAWINGS

The above and other objects and features of the present invention will become apparent from the following description of embodiments given in conjunction with the accompanying drawings, in which:

FIG. 1 is a diagram schematically showing the configuration of a power management system coupled with an electrical appliance in accordance with an embodiment of the present invention;

FIG. 2 is a detailed block diagram of the signal repeater and the wall outlet device shown in FIG. 1;

FIG. 3 is a detailed block diagram of a signal repeater and a wall outlet device in accordance with an alternative embodiment of the present invention; and

FIG. 4 is a flow chart illustrating the operation of the power management system shown in FIG. 1 in accordance with an embodiment of the present invention.

### DETAILED DESCRIPTION OF THE EMBODIMENTS

Embodiments of the present invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

In the following description of the present invention, if the detailed description of the already known structure and operation may confuse the subject matter of the present invention, the detailed description thereof will be omitted. The following terms are terminologies defined by considering functions in the embodiments of the present invention and may be changed operators intend for the invention and practice. Hence, the terms should be defined throughout the description of the present invention.

Combinations of respective blocks of block diagrams attached herein and respective steps of a sequence diagram attached herein may be carried out by computer program instructions. Since the computer program instructions may be loaded in processors of a general purpose computer, a special purpose computer, or other programmable data processing apparatus, the instructions, carried out by the processor of the computer or other programmable data processing apparatus, create devices for performing functions described in the respective blocks of the block diagrams or in the respective steps of the sequence diagram. Since the computer program instructions, in order to implement functions in specific manner, may be stored in a memory useable or readable by a computer aiming for a computer or other programmable data processing apparatus, the instruction stored in the memory useable or readable by a computer may produce manufacturing items including an instruction device for performing functions described in the respective blocks of the block diagrams and in the respective steps of the sequence diagram. Since the computer program instructions may be loaded in a computer or other programmable data processing apparatus, instructions, a series of processing steps of which is executed in a computer or other programmable data processing apparatus to create processes executed by a computer so as to operate a computer or other programmable data processing apparatus, may provide steps for executing functions described in the respective blocks of the block diagrams and the respective steps of the sequence diagram.

Moreover, the respective blocks or the respective steps may indicate modules, segments, or some of codes including at least one executable instruction for executing a specific logical function(s). In several alternative embodiments, it is noticed that functions described in the blocks or the steps may run out of order. For example, two successive blocks and steps maybe substantially executed simultaneously or often in reverse order according to corresponding functions.

Hereinafter, embodiments of the present invention will be described in detail with reference to the accompanying drawings so that they can be readily implemented by those skilled in the art, wherein components denoted by the same reference numerals are referred to the same element or have the same function through the drawings.

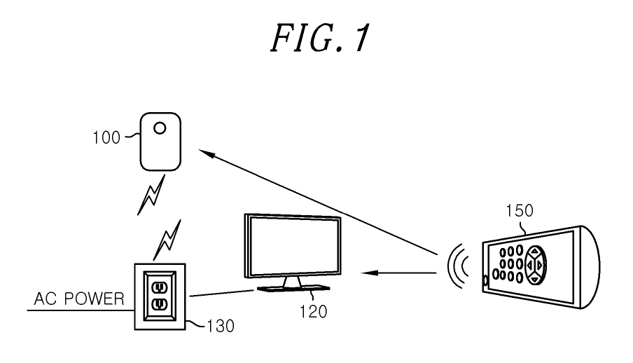

FIG. 1 schematically shows the configuration of a power management system interlocked with an electrical appliance in accordance with an embodiment of the present invention.

Referring to FIG. 1, the power management system includes a wall outlet device 130 and a signal repeater 100. Mounted on a wall surface is the wall outlet device 130 in which one or more electrical appliances 120 are plugged. The respective electrical appliances 120 are controlled to be driven via a remote controller 150. For example, the electrical appliance 120 may include, but not limited to, computers, monitors, television sets, and so on. The signal repeater 100 receives a control signal from the remote controller 150 and transfers it to the wall outlet device 130.

The remote controller 150 directs a control signal from the remote controller 150 toward the electrical appliance 120 which lies in the view range of the remote controller 150. For example, the remote controller 150 generates a power-on signal or a power-off signal for turning-on or turning-off the electrical appliance 120, respectively, when a power-on or a power-off button on the remote controller 150 is pressed. Such a remote controller 150 may be implemented by an infrared remote controller generating infrared control signals or an ultrasonic remote controller generating ultrasonic control signals. The infrared remote controller has a wide view angle and therefore, the infrared remote controller is easily able to control the electrical appliance 120 even though the electrical appliance 120 is out of the line-of-sight from the infrared remote controller to some extent. Therefore, if the signal repeater 100 is placed in the view range of the remote controller 150, the signal repeater 100 can simultaneously receive the same infrared control signal as that received by the electrical appliance 120. Accordingly, the remote controller 150 can simultaneously control the electrical appliance 120 and the wall outlet device 130 as explained below.

The signal repeater 100 is disposed within the line-of-sight from the remote controller 150 capable of receiving the power control signal such as the power-on or power-off signal from the remote controller 150. Further, the signal repeater 100 transmits a power management signal corresponding to the received power control signal to the wall outlet device 130 through a wire/wireless communication scheme.

In the embodiment, it is preferred that the signal repeater 150 is located at a position where a switch for a light is installed in order to enhance a reception efficiency of the power control signal without experiencing the interference with household goods.

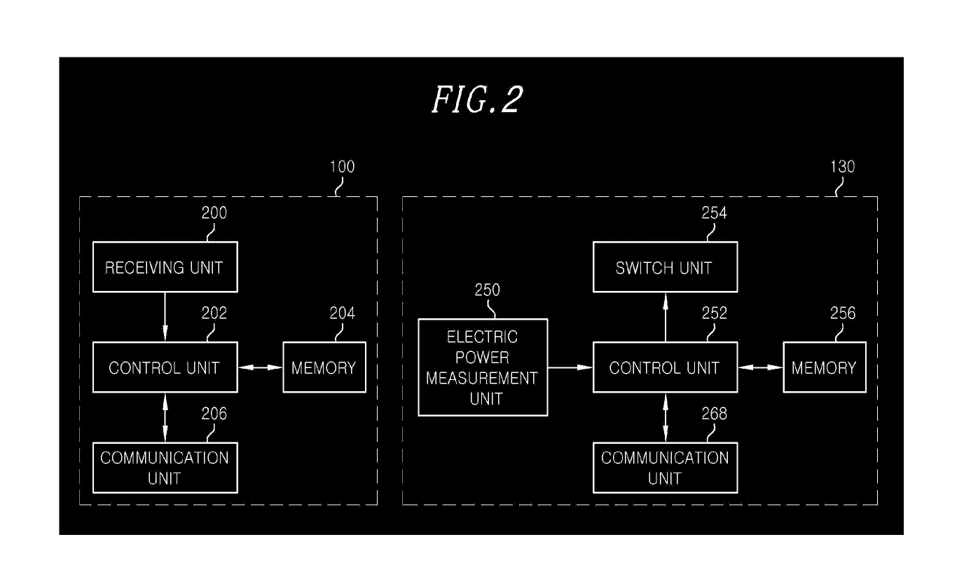

FIG. 2 is a detailed block diagram of the signal repeater and the wall outlet device shown in FIG. 1.

Referring to FIG. 2, the signal repeater 100 includes : a receiving unit 200 for receiving the power control signal from the remote controller 150; a control unit 202 for processing the received power control signal; a memory 204 that stores an operation profile for the power control signal, a program used to control the signal repeater 200, and so on; and a communication unit 206 for transferring a power management signal, which corresponds to the power control signal received by the receiving unit 200, to the wall outlet device 130 in the wire/wireless communication scheme.

In the signal repeater 100, the receiving unit 200 provides the received power control signal to the control unit 202, and the control unit 202 refers to the operation profile for the power control signal in the memory 204 to generate the power management signal corresponding to the power control signal. The power management signal generated by the control unit 202 is transmitted to the wall outlet device 130 through the communication unit 206 in the wire/wireless communication scheme.

The wall outlet device 130 has one or more electrical appliance plugged therein. The wall outlet device 130 includes a measurement unit 250 for measuring an electric power consumed in the wall outlet device 130, i.e., a standby power consumed in the electrical appliance. The wall outlet device 130 further includes: a communication unit 258 for receiving the power management signal from the signal repeater 100; a switching unit 254 for controlling the supply and interruption of electric power from the wall outlet device to the electrical appliance; a control unit 252 for controlling the switching unit 254 based on the power management signal which is provided from the communication unit 258 and the consumed electric power; and a memory 256 that stores an operation program of the wall outlet device 130.

The communication unit 206 within the signal repeater 100 and communication unit 258 within the wall outlet device 130 communicate with each other in either a wire communication scheme employing a variety of wired protocols or a wireless communication scheme which uses at least one of wireless techniques such as RF (Radio Frequency), Wi-Fi (Wireless Fidelity), UWB (Ultra Wide Band), Bluetooth techniques and the like.

The operation of the power management system having the above-mentioned configuration will be explained as follows.

In an initial state that electric power is applied from the wall outlet device 130 to the electrical appliance 120, when a user handles the remote controller 150 to turn-off the electrical appliance 120, a power-off signal is generated from the remote controller 150 and is simultaneously reached both the electrical appliance 120 and the signal repeater 100.

The electrical appliance 120 is immediately turned-off by the power-off signal received from the remote controller 150 and enters into a standby mode. Meanwhile, the signal repeater 100, in response to the power-off signal, generates a power management signal in correspondence with the power-off control signal, which will then be provided to the wall outlet device 130. The power management signal in correspondence with the power-off signal is used as a command instructing the wall outlet device 130 to interrupt the electric power being supplied to the electrical appliance 120. In response to the power management signal from the signal repeater 100, the wall outlet device 130 completely interrupts the power supply for the electrical appliance 120, thereby immediately preventing the standby power consumption of the electrical appliance 120.

In a case where the signal repeater 100 is out of the line-of-sight from the remote controller 150, only the electrical appliance 120 may receive the power-off signal generated from the remote controller 150, whereas the signal repeater 100 may not receive the power-off signal. To overcome this situation, the wall outlet device 130 monitors a standby power, i.e., the electric power consumed by the electrical appliance 120 in a standby mode. If the consumed electric power is less than the threshold value during a fixed time period, the wall outlet device 130 automatically interrupts the electric power to the electrical appliance 120, thereby preventing a standby power consumption. If, however, the consumed electric power is not less than the threshold value, the wall outlet device 130 determines that the electrical appliance 120 is being driven and continues to supply the electric power to the electrical appliance 120.

On the other hand, if a user handles the remote controller 150 in order to drive the electrical appliance 120 having a state that the supply of the electric power has been interrupted by the wall outlet device 130, a power-on signal is generated in the remote controller 150 and is directed to the electrical appliance 120 and the signal repeater 100. However, the electrical appliance 120 cannot be immediately driven by the power-on signal because the electric power to the electric appliance 120 has been completely interrupted by the wall outlet device 130.

Meanwhile, the signal repeater 100 receives the power-on signal and generates the power management signal, which corresponds to the power-on signal. As described above, the power management signal in correspondence with the power-on signal is used as a command constructing the wall outlet device 130 to provide the electric power to the electrical appliance 120. Therefore, the wall outlet device 130 receiving the power management signal is switched from the interruption of electric power to the electric appliance into the supply of electric power to the electric appliance. Then, the electric power is supplied to awake the electrical appliance 120, so that the electric appliance is ready for receiving the power-on signal from the remote controller 150. Thereafter, the user presses a power-on button on the remote controller 150 once again to turn-on the electrical appliance 120.

In this manner, when the user presses the power-on button on the remote controller 150 once more, the signal repeater 100 receives the power-on signal twice and repeatedly produces the power management signal corresponding to the power-on signal twice. In this case, the wall outlet device 130 maybe configured to ignore or does not reaction to the repeated power management signal on the basis of the operation profile stored in the memory 256.

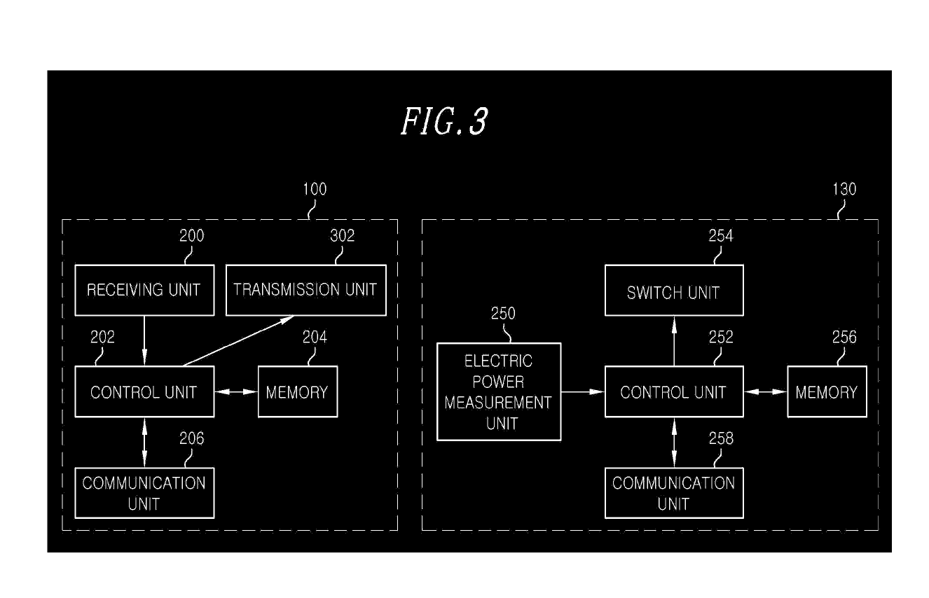

FIG. 3 is a detailed block diagram of a signal repeater and a wall outlet device in accordance with an alternative embodiment of the present invention to overcome the situation of pushing the power button on remote controller twice as set forth above.

The signal repeater 300 and the wall outlet device 130 of FIG. 3 have substantially the same configurations as the signal repeater 100 and the wall outlet device 130 of FIG. 2, respectively, excepting further including a transmission unit 300. Accordingly, the detailed description on the same components of FIG. 3 as those of FIG. 2 will be omitted.

In this embodiment, the transmission unit 302 is configured to generate the same power-on signal as that received by the receiving unit 200 and provide the generated power-on signal to the electrical appliance 120, so that the electrical appliance 120 receives the copied power-on signal from the signal repeater 300 as if it is directly provided from the remote controller 150. In other words, the alternative embodiment of FIG. 3 enables the signal repeater 300 to relay the same power-on signal as that received from the remote controller 150 toward the electrical appliance. Therefore, the electrical appliance 120 can be turned-on by the power-on signal received from the signal repeater 300 immediately after the wall outlet device 130 is switched into the status of supplying power to the electrical appliance 120.

Actually, if the transmission intensity at the transmission unit 302 is high, the output from the transmission unit 302, i.e., the copied power-on signal, can sufficiently reach the electrical appliance 120 through reflection by wall surfaces, even though the electrical appliance 120 is out of the line-of-sight to some extent from the transmission unit 302. Accordingly, the alternative embodiment with the above-mentioned configuration enables the user to turn-on the electrical appliance 120 by pressing the power button on the remote controller 150 just one time.

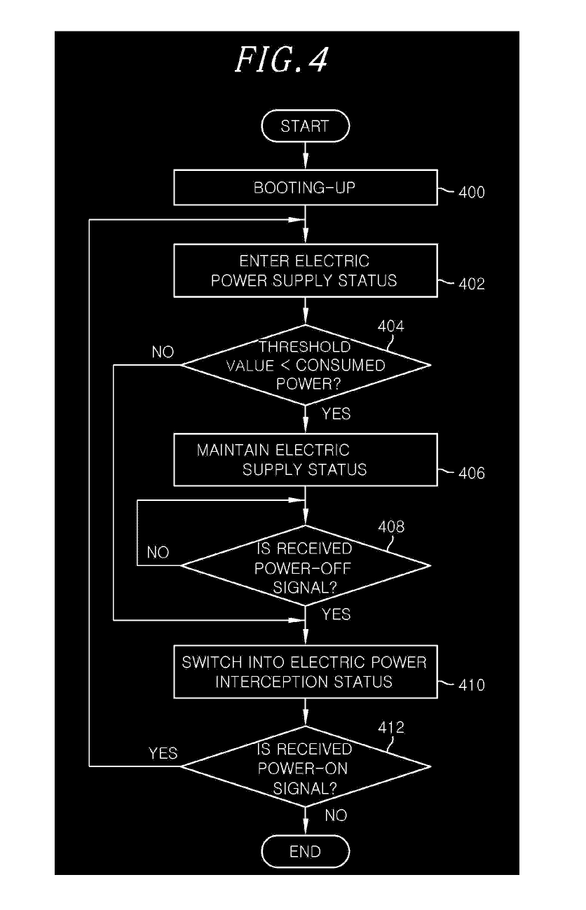

FIG. 4 is a flow chart illustrating the operation of the power management system which is coupled with an electrical appliance, in accordance with an embodiment of the present invention.

At step 400, the wall outlet device 130 is booted-up to be initialized.

At step 402, the booted-up wall outlet device 130 enters a status of supplying power to the electrical appliance 120 which is plugged in it.

Thereafter, at step 404, the wall outlet device 130 measures an electric power consumed by the electrical appliance 120, and compares the consumed electrical power with a threshold value. If the consumed electrical power is less than the threshold value for a fixed time period, the wall outlet device 130 determines that the electrical appliance 120 stays in a standby mode and switches the power supply status into a power interruption status of interrupting the power being supplied to the electrical appliance 120 in step 410.

On the other hand, when the compared resultant of the step 404 indicates that the consumed electric power is not less than the threshold value, the wall outlet device 130 continues to maintain the power supply status in step 406.

Thereafter, in step 408, the wall outlet device 130 waits for a power management signal corresponding to a power-off signal to be receive via the signal repeater 130 in the power supply status. If the power management signal corresponding to a power-off signal is received from the signal repeater, the wall outlet device 130 recognizes the received power management signal as a user's intent, which turns-off the electrical appliance 120, and enters the power interruption status for the electrical appliance 120 in step 410.

Meanwhile, when a power management signal corresponding to a power-on signal is received from the signal repeater 130 in the power interruption status, the wall outlet device 130 determines the power-on signal as a user's intent, which turns-on the electrical appliance 120, and re-enters the power supply status for the electrical appliance 120.

As described above, according to embodiments of the present invention, when the user wants to turn-off the electrical appliance, the wall outlet device immediately interrupts power being supplied to the electrical appliance. Therefore, the standby power consumed during the fixed time period necessary to monitor the standby mode of the electrical appliance can also be reduced. Moreover, the embodiments of the present invention are implemented to control not only power of the electrical appliance but also the supply and interruption for power being supplied from the wall outlet device to the electrical appliance. As such, it can enhance the convenience of a user.

While the invention has been shown and described with respect to the preferred embodiments, it will be understood by those skilled in the art that various changes and modifications may be made without departing from the scope of the invention as defined in the following claims.

What is claimed is:

1. A power management system comprising:
a wall outlet device having an electrical appliance plugged therein and configured to selectively perform the supply of electric power to the electrical appliance or the interruption of electric power being supplied to the electrical appliance in response to a power management signal; and
a signal repeater configured to receive a power control signal from a remote controller and generate the power management signal in correspondence with the power control signal, wherein the power control signal includes a power-on signal or a power-off signal used to turn-on or turn-off the electrical appliance, respectively.

2. The power management system of claim 1, wherein the wall outlet device comprises:
a communication unit for receiving the power management signal from the signal repeater;
a measurement unit for measuring electric power being consumed in the electrical appliance;
a switching unit for selectively supplying the electric power to the electrical appliance or interrupting the electric power being supplied to the electrical appliance; and
a control unit for controlling the switching unit depending on the power management signal and/or the consumed electric power.

3. The power management system of claim 2, wherein the control unit is configured to:
supply the electric power to the electrical appliance when the power management signal in correspondence with the power-on signal is received, in a status that the supply of electric power to the electrical appliance has been interrupted; and
interrupt the electric power to the electrical appliance when the power management signal in correspondence with the power-off signal, in a status that the electric power is being supplied to the electrical appliance.

4. The power management system of claim 2, wherein the control unit is configured to:
continue the supply of the electric power to the electrical appliance when the consumed electric power during a fixed time period is not less than a threshold value, in a status that the electric power is being supplied to the electrical appliance; and
interrupt the electric power to the electrical appliance when the consumed electric power in the electrical appliance during a fixed time period is less than a threshold value, in a status that the electric power is being supplied to the electrical appliance.

5. The power management system of claim 1, wherein the signal repeater comprises:
a receiving unit for receiving the power control signal from the remote controller;
a control unit for generating the power management signal in correspondence with the received power control signal; and
a communication unit for transmitting the power management signal to the wall outlet device.

6. The power management system of claim 5, further comprising a transmission unit for transmitting the same power-on signal as that received by the receiving unit to the electrical appliance in a state that the supply of electric power to the electrical appliance has been interrupted.

7. A method of managing electric power in a power management system including a signal repeater and a wall outlet device having an electrical appliance plugged therein, the method comprising:
receiving, at the signal repeater, a power control signal from a remote controller to generate a power management signal in correspondence with the power control signal, wherein the power control signal includes a power-on signal or a power-off signal used to turn-on or turn-off the electrical appliance, respectively; and
selectively performing, at the wall outlet device, in response to the power management signal, the supply of electric power to the electrical appliance or the interruption of electric power to the electrical appliance.

8. The method of claim 7, wherein the supply of electric power to the electrical appliance is performed when the power management signal in correspondence with the power-on signal is received, in a status that the electric power to the electrical appliance has been interrupted; and
wherein the interruption of electric power to the electrical appliance is performed when the power management signal in correspondence with the power-off signal is received, in a status that the electric power is being supplied to the electrical appliance.

9. The method of claim 7, wherein further comprising:
measuring, at the wall outlet device, a consumed electric power in the electrical appliance during a fixed time period, in a state that the electric power is being supplied to the electrical appliance;
continuing to supply the electric power to the electrical appliance if the consumed electric power is not less than a threshold value; and
interrupting the electric power being supplied to the electrical appliance when the consumed electric power is less than a threshold value.

10. The method of claim 7, further comprising:
transmitting the same power-on signal as that received by the signal repeater to the electrical appliance in a state that the supply of electric power from the wall outlet device has been interrupted.
